(19) United States
(12) Patent Application Publication
(10) Pub. No.: US 2024/0213903 A1
(43) Pub. Date: Jun. 27, 2024

(54) AUXILIARY POWER SUPPLIES USING MOTOR WINDING INDUCTANCE

(71) Applicant: POWER INTEGRATIONS, INC., San Jose, CA (US)

(72) Inventors: David Michael Hugh Matthews, Los Gatos, CA (US); William Michael Polivka, Campbell, CA (US)

(73) Assignee: POWER INTEGRATIONS, INC., San Jose, CA (US)

(21) Appl. No.: 18/085,887

(22) Filed: Dec. 21, 2022

(51) Int. Cl. H02P 25/18; H02K 3/28; H02P 27/06

(52) U.S. Cl. CPC H02P 25/18; H02K 3/28; H02P 27/06

(57) ABSTRACT

A motor driver couples to an auxiliary power supply and to a motor having a winding. The motor driver comprises a switching circuit that has an auxiliary node coupled to the auxiliary power supply and a winding node coupled to the winding. The switching circuit is configured to store energy in the inductance of the motor winding and to deliver energy the auxiliary power supply. To store energy, the switching circuit and the winding are coupled to establish a current in the winding. To deliver energy, the switching circuit delivers the current in the winding to the auxiliary node.

### BACKGROUND OF THE INVENTION

### Field of the Invention

The present invention relates generally to auxiliary power supplies used with motor drivers.

### Discussion of the Related Art

Motor drive inverters, e.g. half-bridge motor driver circuits, typically use an auxiliary power supply to generate the power source for the power transistor drivers and microprocessor that controls the operation of the motor.

Some half-bridge motor driver circuits include a self-starting feature that can support their operation indefinitely by using high voltage (HV) linear regulators deriving power from the same HV dc bus that provides power to the motor. However, even if the half-bridge motor driver circuit can power itself, the additional power used by a system microcontroller (MCU) and other circuitry generally results in excessive power dissipation from the linear regulator.

One previous solution is to have an auxiliary switching power supply, typically either a buck converter or a flyback converter, that efficiently derives power for the motor drive inverters directly from the high voltage bus through a dedicated inductive energy transfer element. This auxiliary power supply comes with the penalty of additional cost and consumption of space on a circuit board.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a functional block diagram showing an auxiliary power supply in a motor drive system that includes a half-bridge motor driver circuit, in accordance with an embodiment of the present disclosure.

FIG. 2 is a functional block diagram showing the current path for an auxiliary power supply in a switched-mode power converter, in accordance with an embodiment of the present disclosure.

FIG. 3 is a timing diagram illustrating operation of an embodiment for obtaining current from a motor winding.

FIG. 4 is a timing diagram illustrating operation of an additional embodiment for obtaining current from a motor winding.

FIG. 5 is a timing diagram illustrating operation of an additional embodiment for obtaining current from a motor winding.

FIG. 6 is a timing diagram illustrating operation of an additional embodiment for obtaining current from a motor winding.

FIG. 7 is a timing diagram illustrating operation of an additional embodiment for obtaining current from a motor winding.

FIG. 8 is a timing diagram illustrating operation of an additional embodiment for obtaining current from a motor winding.

FIG. 9 is a circuit schematic of an embodiment for a portion of the half bridge motor driver circuit shown in FIG. 1.

FIG. 10 is a circuit schematic of an embodiment for a portion of the half-bridge motor driver circuit shown in FIG. 1.

FIG. 11 illustrates a circuit schematic of an embodiment for a portion of the half-bridge motor driver circuit shown in FIG. 1 that includes an auxiliary switch for the auxiliary power supply.

FIG. 12 illustrates another circuit schematic of an embodiment for a portion of the half-bridge motor driver circuit shown in FIG. 1 that includes an auxiliary switch for the auxiliary power supply.

FIG. 13 is a timing diagram illustrating operation of an embodiment for obtaining current from a motor winding in accordance with the embodiments shown in FIG. 12.

FIGS. 14A, 14B, and 14C illustrate additional embodiments of the system shown in FIG. 1.

FIG. 15 is a functional block diagram in accordance with another embodiment of the present disclosure.

FIG. 16 is a process flowchart according to an embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted to facilitate a less obstructed view of these various embodiments of the present invention.

### DETAILED DESCRIPTION

In the following description, numerous specific details are set forth to provide a thorough understanding of the present invention. It will be apparent, however, to one having ordinary skill in the art that the specific detail need not be employed to practice the present invention. In other instances, well-known materials or methods have not been described in detail to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

A motor drive inverter, e.g. a configuration of one or more half-bridge motor driver circuits may include control circuitry that may be coupled to a motor winding having a winding inductance via a switching circuit. In a first state, the switching circuit is configured to take current from a high voltage power source that powers the motor and to store energy in the winding as current in the inductance of the winding. In a second state, the switching circuit is further configured to deliver the stored energy to an auxiliary power supply by switching, delivering, or diverting the current in the winding to the input of the auxiliary power supply. The first and second states are based on operating parameters of the auxiliary power supply, the motor, and the motor drive inverter. The operating parameters may include duty cycle (the ratio of the time while a switch is in a first state to the total time in the first state plus the time in a second state), current in the winding, and the needs of an auxiliary power supply for input current to provide a regulated output voltage. The motor driver circuits may be housed within one or more electronic packages so that they can be used as part of a printed circuit board circuit. The control circuitry may be housed within the same electronic package as the motor driver circuits or as separate circuits housed in one or more other electronic packages. Control circuitry may comprise of circuits such as microcontroller units (MCUs) that can be programmed to provide electronic signals to the motor driver circuits to control the currents in the motor windings to which they are coupled.

The inherent inductance of a motor winding is used as the energy storage element to perform the power conversion from the high voltage de bus to a substantially lower voltage at the input to the auxiliary power supply. In one embodiment, existing inverter power transistors may be used as the switching transistors that provide the current to the auxiliary power supply. Thus, switching power conversion for the auxiliary power supply reuses circuitry that already exists for the motor inverter operation and avoids the unacceptable power dissipation that could occur with a linear regulator. Furthermore, using the inductance of a motor winding eliminates the need to have a dedicated inductive energy transfer element in an auxiliary power supply that operates directly from the high voltage bus. In other words, the switches of the motor inverter may be switches in a switched-mode power converter having an inductive energy transfer element that is also a winding of a motor. The input of the switched-mode power converter may be the high voltage input source for the motor and the output of the switched-mode power converter may be the input to an auxiliary power supply.

The invention may use existing inverter power switches such as field-effect transistors (FETs), insulated gate bipolar transistors (IGBTs), and enhancement mode Gallium Nitride transistors (GaN) etc. for the switch circuitry. Another embodiment uses a cascode power switch comprising a high voltage normally-on transistor, e.g. a normally-on GaN transistor, Silicon Carbide (SiC) transistor or junction field effect transistor (JFET), coupled to a cascode low voltage (LV) FET. In that configuration, the low voltage FET is turned off by the controller during a standard switch cycle to temporarily deliver current from a motor winding to the input of an auxiliary power supply. Thus, the switching circuitry may be used to power both the driver integrated circuits (ICs) and auxiliary circuitry such as a system microcontroller (MCU) during either normal motor operation or when the motor is stationary.

When the motor is stationary, some of the inverter switches may be turned on for a short time to provide current for a relatively low power auxiliary power supply to power the auxiliary circuitry. For illustrative purposes, a short time is less than what is typically used to move the motor. The auxiliary circuitry can include the power switch drivers, system MCU, and ICs. For purposes of illustration, the power used for system MCU ICs in standby will be typically between 3 milliwatts and 10 milliwatts. The motor winding currents generated may be controlled to be of a sufficiently low value during any switching cycle such that negligible force is generated to limit motion of the motor. Furthermore, the frequency of switching will be restricted such that motor inertia, friction, and loading may also minimize motor movement.

When the motor is in motion, some of the inverter switches may be turned off for a relatively short time within a typical inverter switching cycle to provide current for a relatively low power auxiliary power supply to power the auxiliary circuitry. The motor winding currents may be controlled to increase the current in the winding above a value that results in motor motion. Furthermore, the frequency of switching may be restricted until there is sufficient current to produce motion of the motor and still provide current to the auxiliary power supply.

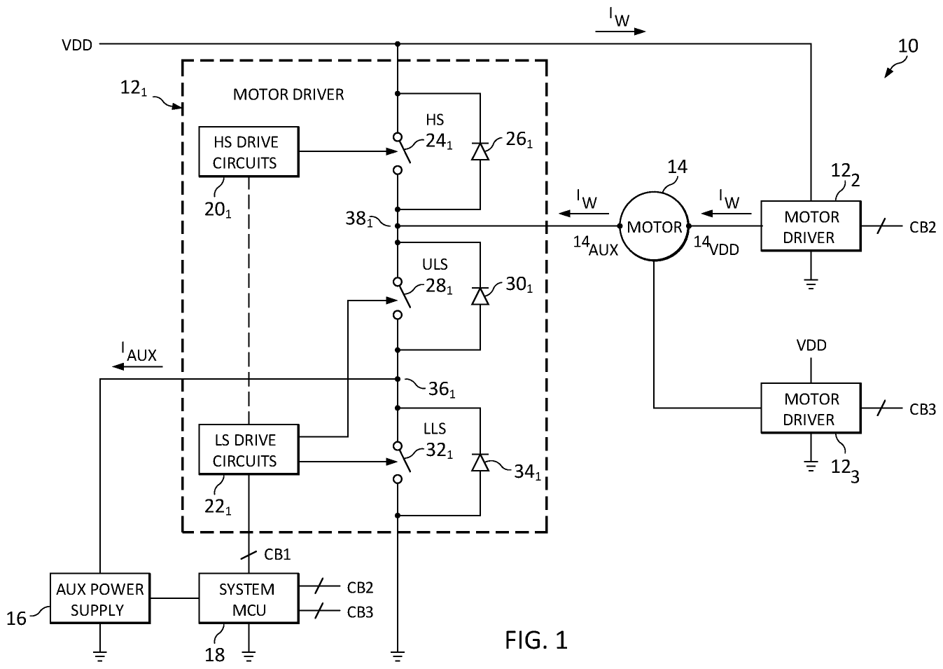

FIG. 1 is a functional block diagram 10 in accordance with embodiments of the present disclosure. A winding of a motor 14 is coupled to three half-bridge motor driver circuits 12₁, 12₂, 12₃. Each of the half-bridge motor driver circuits 12₁, 12₂, 12₃ is coupled between VDD (typically a high voltage dc source) and reference ground and may be further coupled to an auxiliary power supply. Illustratively, the half-bridge motor driver circuit 12₁ is shown coupled to an auxiliary power supply 16. The circuitry within motor driver 12₁ may collectively be referred to as a switching circuit. A system MCU 18 is configured to provide control signals CB1, CB2, CB3 to the high side (HS) Drive Circuits, e.g. 20₁, and to the low side (LS) Drive Circuits, e.g. 22₁, of the half-bridge motor driver circuits, respectively. It is appreciated that each signal, CB1, CB2, and CB3, may comprise two or more signal lines in a real motor inverter drive and are therefore notated as signal buses. MCU 18 is one example of control circuitry discussed above which, in the embodiment of FIG. 1 is shown as circuitry external to the motor driver 12₁. It is appreciated that in other embodiments, control circuitry 18 could be integrated within one of the motor drivers 12₁, 12₂, or 12₃.

Half-bridge motor driver circuit 12₁ includes a high side (HS) switch 24₁ in parallel with a diode 26₁. The HS switch 24₁ couples to VDD and is coupled to a winding of a motor 14. The HS switch 24₁ is configured to be driven by the high side (HS) drive circuits 20₁. An upper low side (ULS) switch 28₁ is in parallel with a ULS diode 30₁. The ULS switch 28₁ is coupled to a winding of motor 14 at winding node 38₁ and to the auxiliary power supply 16 at the auxiliary (AUX) node 36₁. A lower low side (LLS) switch 32₁ is in parallel with a LLS diode 34₁. The LLS switch 32₁ is coupled between the AUX node 36₁ and the reference ground. Both the ULS and the LLS switches 28₁, 32₁ are configured to be driven by the LS Drive Circuits 22₁. The auxiliary power supply 16 is coupled between the AUX node 36₁ and reference ground. Examples of an auxiliary power supply include a low voltage switched-mode power supply and a linear regulated power supply.

The operation of the energy storage and current delivery is illustratively described using the example in FIG. 1 of the winding of motor 14 coupled to two half-bridge motor driver circuits 12₁, 12₂. Two half-bridge motor driver circuits 12₁, 12₂ are used to conduct current that may store energy in the winding of motor 14 and to deliver the current to the auxiliary power supply 16. Each half-bridge motor driver circuit 12₁, 12₂ configures its respective switching circuitry in response to receiving its corresponding control signal CB1, CB2, transmitted by the system MCU 18. Switching signals within the half-bridge motor driver circuits indicate when to increase or decrease current in the winding and when to deliver a portion of the current I_{W} from the AUX node 36₁ to the auxiliary power supply 16.

It is appreciated that in a typical motor, the winding of motor 14 could be made up of several windings often referred to as phase windings of the motor but are consolidated into a single winding for simplicity in this description.

To increase current in the winding, the HS switch (not shown) in the half-bridge motor driver circuit 12₂ at a first end 14_{VDD} of the winding of motor 14 is closed. A switch that is closed may conduct current, whereas a switch that is open conducts negligible current. In the half-bridge motor driver circuit 12₁ that couples to the auxiliary power supply 16 and to the second end 14_{AUX} of the winding of motor 14, the HS switch may be opened and the ULS and LLS switches 28₁, 32₁ may be closed and opened in an appropriate manner to drive the motor and to provide current to the auxiliary power supply.

For the half-bridge motor driver circuit 12₁ at the second end 14_{AUX} of the winding, to establish current I_{W} in the winding, the HS switch 24₁ may be opened and switches ULS 28₁ and LLS 32₁ may be closed. Then to deliver the current I_{W} in the winding to the auxiliary power supply 16, the HS switch 24₁ may remain open while the ULS switch 28₁ may remain closed and the LLS switch 32₁ may be opened.

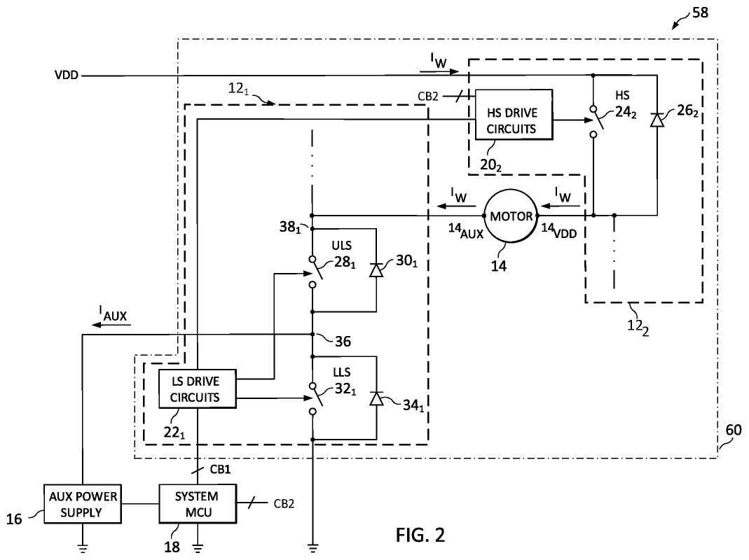

FIG. 2 is a functional block diagram 58 showing the current path for an auxiliary power supply in a switched-mode power converter 60, in accordance with an embodiment of the present disclosure. The switched-mode power converter 60 is coupled between VDD and reference ground, and further coupled to the auxiliary power supply 16 and the system MCU 18. The switched-mode power converter is a dc-to-dc converter that stores energy from a high voltage input VDD and delivers the energy at a lower voltage to the input of the auxiliary power supply.

The switched-mode power converter 60 in the example of FIG. 2 includes a winding of a motor 14, the high side circuitry of the half-bridge motor driver circuit 12₂, and the low side circuitry of the half-bridge motor driver circuit 12₁.

The high side circuitry of the half-bridge motor driver circuit 12₂ includes a HS switch 24₂ in parallel with a diode 26₂, and HS drive circuits 20₂. The HS switch 24₂ is further coupled to VDD and is coupled to the winding of the motor 14.

The low side circuitry of the half-bridge motor driver circuit 12₁ includes a ULS switch 28₁ in parallel with a ULS diode 30₁, a LLS switch 32₁ in parallel with a LLS diode 34₁, and LS drive circuits 22₁.

The system MCU 18 is configured to provide signal CB1 to the LS Drive Circuits 22₁ and signal CB2 to the HS Drive Circuits 20₂.

In operation, the winding of motor 14 may be coupled to the HS switch 24₂ and the ULS switch 28₁. The switching circuit conducts current that may store energy in the winding of motor 14 and may deliver a portion of the energy as current to the auxiliary power supply. The switching circuit responds to the control signals CB1, CB2 transmitted by the system MCU 18.

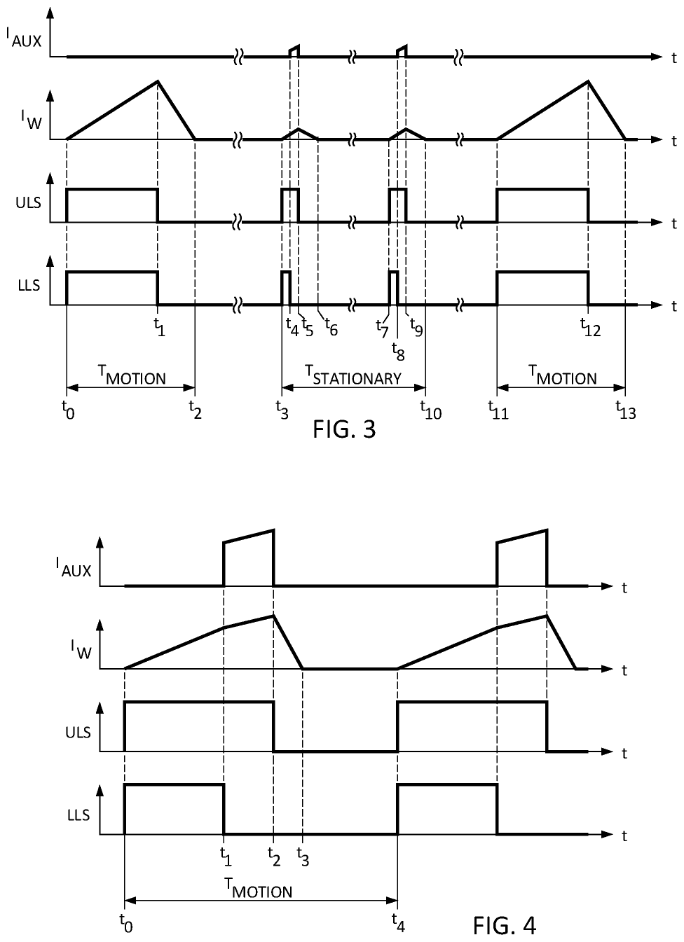

The LS drive circuit 22₁ of the half-bridge motor driver circuit 12₁ responds to control signal CB1 and the HS drive circuits 20₂ responds to the control signal CB2. The control signals CB1, CB2 may be transmitted by the system MCU 18 in accordance with one of the timing diagrams disclosed in FIGS. 3-7. As shown in FIG. 2, the HS switch 24₂ of the half bridge motor driver circuit 12₂ at the 14_{VDD} end of the winding delivers current I_{W} to the winding when it receives a drive signal from the HS drive circuit 20₂. In combination, the ULS and LLS switches 28₁, 32₁ of the half bridge motor driver circuit 12₁ at the 14_{AUX} end of the winding may switch appropriately to increase and decrease current in the winding and to deliver a portion of the current I_{W} from the AUX node 36 to the auxiliary power supply 16 when the auxiliary power supply 16 requires it.

FIGS. 3-8 are timing diagrams illustrating operation of embodiments for obtaining current I_{AUX} from the motor winding as shown in the example functional block diagram of FIG. 2. In operation, the current may be increased in the winding without generating continuous motor motion when the motor is stationary and the switching circuit is configured to deliver current. The current may be increased in the winding above a threshold that generates motor motion when the motor is in motion and the switching circuit is configured to deliver current.

FIG. 3 is a timing diagram illustrating operation of an embodiment for obtaining current from a motor winding. In FIG. 3, Graph LLS shows the state of the LLS switch 32₁ in the functional block diagram of FIG. 2. Graph ULS shows the state of the ULS switch 28₁ in the functional block diagram of FIG. 2. A high state indicates that the switch is closed, whereas a low state indicates that the switch is open. Graph I_{W} shows the current in the winding of motor 14. A positive current I_{W} indicates current in the direction from winding terminal 14_{AUX} to node 38₁ whereas a negative current I_{W} indicates current flowing from node 38₁ to winding terminal 14_{AUX}. Graph I_{AUX} shows current at the input to the auxiliary power supply 16. For the purposes of the following figure descriptions, when a positive current I_{W} is present and increasing in the motor winding it is assumed that the HS switch in the half-bridge motor driver circuit 12₂ coupled to the first end 14_{VDD} of the motor winding is closed and the HS switch 24₁ shown in FIG. 1 in the half-bridge motor driver circuit 12₁ coupled to the second end 14_{AUX} of the motor winding is open in order to allow current in the motor winding.

In FIG. 3, current I_{AUX} is delivered to the input of the auxiliary power supply 16 when the motor 14 is stationary during the duration T_{STATIONARY}.

When the motor is in motion during the time T_{MOTION}, the ULS and the LLS switches 28₁, 32₁ are closed at t₃, and current I_{W} from the HV dc bus VDD begins to increase in the winding. At t₁, the ULS and the LLS switches 28₁, 32₁ are opened to allow current I_{W} to return to the VDD power supply rail through diode 26₁. At t₂, current I_{W} reaches its lowest value and there is negligible current in the winding.

When the motor is stationary during time T_{STATIONARY}, the ULS and the LLS switches 28₁, 32₁ are closed at t₃, and current I_{W} begins to increase. At ta, when current I_{W} reaches a threshold, the LLS switch 32₁ is opened to allow current I_{W} to be delivered to the auxiliary power supply 16 and the current I_{AUX} is equal to the current I_{W}. In another embodiment, only a part of the current I_{W} is delivered and the current I_{AUX} is a portion of I_{W}. At t₅, the ULS switch 28₁ is opened to allow current I_{W} to return to the VDD power supply rail through diode 26₁ for example and the current I_{AUX} reaches its lowest value which in one example could be substantially zero or negligible current. At t₆, there is negligible current in the winding. The events repeat at times t₇, t₈, and to t₉ provide current I_{AUX} to the input of the auxiliary power supply 16. In the above and subsequent descriptions below it is appreciated that, in a practical motor control system, during time T_{STATIONARY}, the introduction of current I_{AUX} to provide an auxiliary power supply may initially introduce a small torque that is applied to the rotor of the motor in the system. As such, an initial small angular motion in the motor rotor may be introduced for the first few pulses of I_{AUX} current supplied to the auxiliary power supply during T_{STATIONARY}. However, this motion is temporary since during T_{STATIONARY}, the motor winding currents are not excited in a sequence to generate continuous motion as is the case during T_{MOTION}. As such, the period T_{STATIONARY} shall be referred to as the motor being stationary rather than the continuous rotation that is the case during T_{MOTION}.

FIG. 4 is a timing diagram illustrating operation of an additional embodiment for obtaining current from a motor winding. In FIG. 4, current I_{AUX} is delivered to the input of the auxiliary power supply 16 when the motor 14 is in motion during time T_{MOTION}.

At t₀, the ULS and the LLS switches 28₁, 32₁ are closed. Current I_{W} begins to increase. At t₁, the LLS switch 32₁ is opened to allow current I_{AUX} to enter the auxiliary power supply 16. At t₂, the ULS switch 28₁ is opened and the current I_{W} decreases. At t₃, there is negligible current in the winding. The sequence repeats at time t₄.

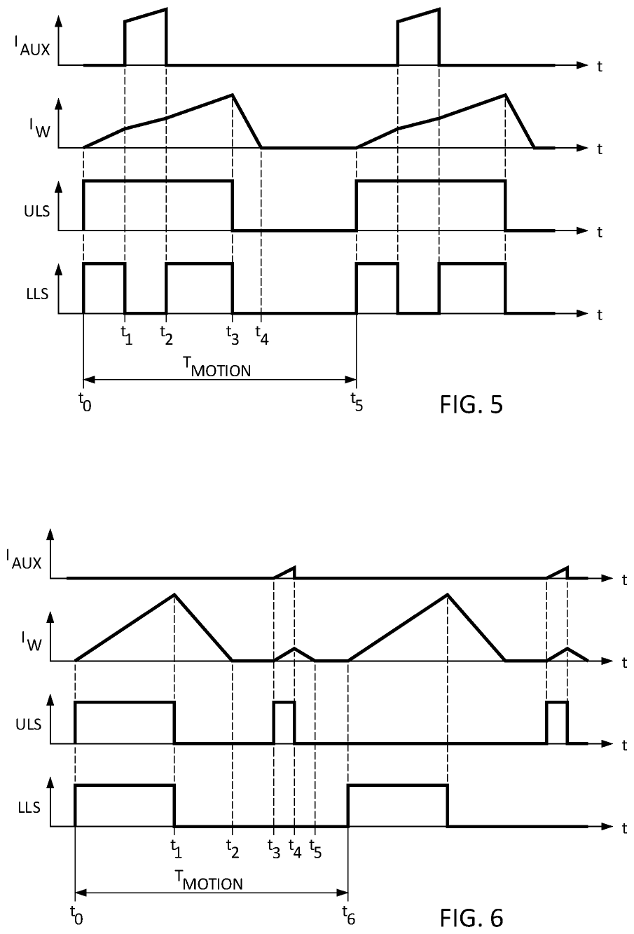

FIG. 5 is a timing diagram illustrating operation of an additional embodiment for obtaining current from a motor winding. In FIG. 5, current I_{AUX} is delivered to the input of the auxiliary power supply 16 when the motor 14 is in motion during time T_{MOTION}. In this example, the current I_{W} is delivered once to the auxiliary power supply 16 and then returned to the VDD power supply rail.

At t₀, the ULS and the LLS switches 28₁, 32₁ are closed. Current I_{W} begins to increase. At t₁, the LLS switch 32₁ is opened to allow current I_{AUX} to enter the auxiliary power supply 16.

At t₂, the LLS switch 32₁ is closed and current I_{AUX} goes to zero. At t₃, the ULS and the LLS switches 28₁, 32₁ are opened to allow current I_{W} to return to the VDD power supply rail through diode 26₁. At t₄, there is negligible current in the winding.

FIG. 6 is a timing diagram illustrating operation of an additional embodiment for obtaining current from a motor winding. In FIG. 6, current I_{AUX} is delivered to the input of the auxiliary power supply 16 when the motor 14 is in motion during time T_{MOTION}.

At t₀, the ULS and the LLS switches 28₁, 32₁ are closed. Current I_{W} begins to increase. At t₁, the ULS and the LLS switches 28₁, 32₁ are opened to allow current I_{W} to return to the VDD power supply rail through diode 26₁ for example. At t₂, there is negligible current in the winding.

At t₃, the ULS switch 28₁ is closed, current increases in the winding and current I_{AUX} is delivered to the input of the auxiliary power supply 16. At ta, the ULS switch 28₁ is opened to allow current I_{W} to return to the VDD power supply rail through diode 26₁ for example. At t₅, there is negligible current in the winding.

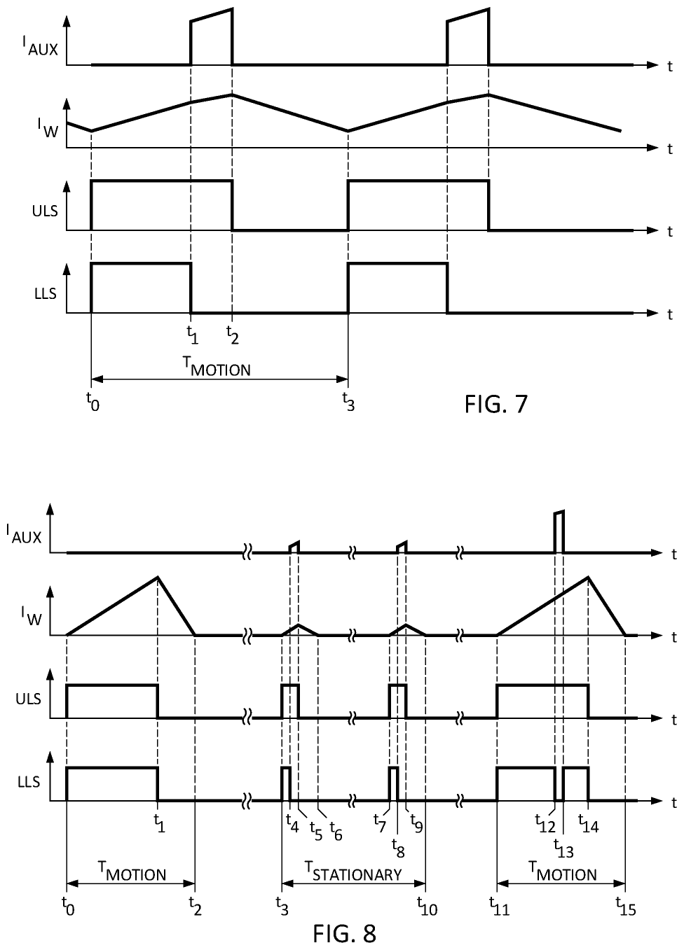

FIG. 7 is a timing diagram illustrating operation of an additional embodiment for obtaining current from a motor winding. In FIG. 7, current is delivered to the input of the auxiliary power supply 16 when the motor 14 is in motion during time T_{MOTION}.

At t₀, the ULS and the LLS switches 28₁, 32₁ are closed. Current I_{W} begins to increase from a non-zero value. At t₁, the LLS switch 32₁ is opened to allow current I_{AUX} to enter the input of the auxiliary power supply 16. At t₂, the ULS switch 28₁ is opened to stop current from entering input of the auxiliary power supply, allowing current I_{W} to return to the VDD power supply rail through diode 26₁ for example. At t₃, current in the winding again increases from a non-zero value.

FIG. 8 is a timing diagram illustrating operation of an additional embodiment for obtaining current from a motor winding. In FIG. 8, current is delivered at multiple intervals when the motor is in motion during time T_{MOTION} and when the motor is stationary during time T_{STATIONARY}.

When the motor is in motion T_{MOTION}, at t₀, the ULS and the LLS switches 28₁, 32₁ are closed. Current I_{W} begins to increase. At t₁, the ULS and the LLS switches 28₁, 32₁ are opened to allow current I_{W} to return to the VDD power supply rail through diode 26₁ for example. There is no switching to deliver current to the input of the auxiliary power supply. At t₂, there is negligible current in the winding.

When the motor is stationary during time T_{STATIONARY}, at t₃, the ULS and the LLS switches 28₁, 32₁ are closed. Current I_{W} begins to increase. At ta, the LLS switch 32₁ is opened to allow current I_{AUX} to enter the input of the auxiliary power supply 16. At t₅, the LLS switch 28₁ is opened to allow current I_{W} to return to the VDD power supply rail through diode 26₁ for example. At t₆, there is negligible current in the winding. The sequence may repeat at times t₇, t₈, t₉, and t₁₀ to provide current to the input of the auxiliary power supply.

When the motor is in motion during time T_{MOTION}, at t₁₁, the ULS and the LLS switches 28₁, 32₁ are closed. Current I_{W} begins to increase. At t₁₂, the LLS switch 32₁ is opened to allow current I_{AUX} to enter the input of the auxiliary power supply 16. At t₁₃, the LLS switch 28₁ is closed. At t₁₄, the ULS and the LLS switches 28₁, 32₁ may be opened to allow current I_{W} to return to the VDD power supply rail through diode 26₁ for example. At t₁₅, there is negligible current in the winding.

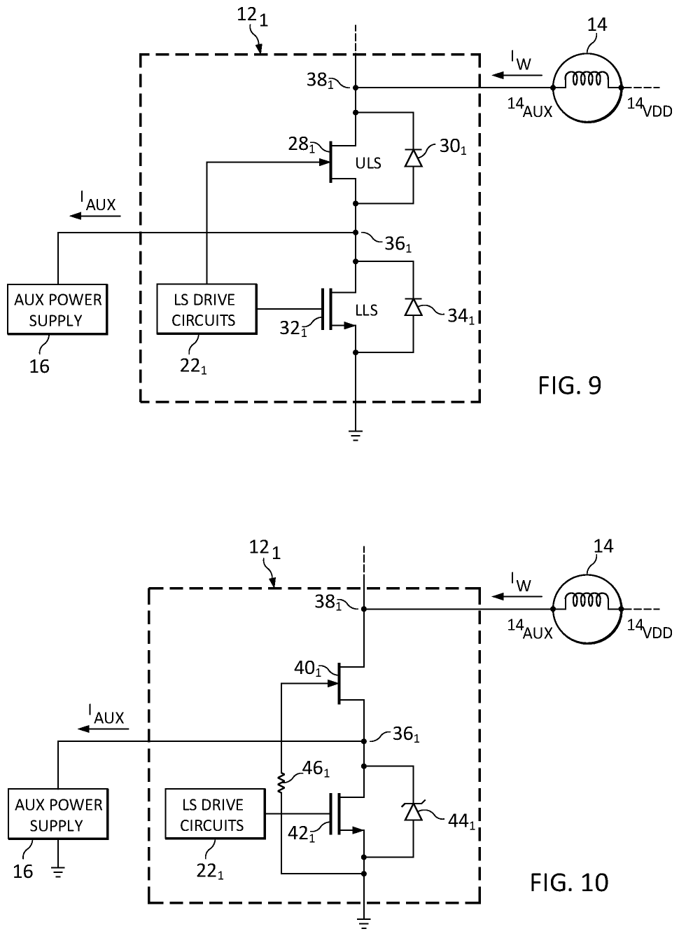

FIG. 9 is a circuit schematic of an embodiment for the half-bridge motor driver 12₁ shown in FIG. 1. The ULS switch 28₁ is a normally-on transistor that has a switch input coupled to receive current I_{W} from the motor winding at 14_{AUX} and a switch output coupled to the AUX node 36₁. The LLS switch 32₁ is a normally-off transistor that has an input coupled to the AUX node 36₁ and an output coupled to reference ground. The LS Drive Circuits 22₁ receive a control signal from the system MCU 18 (not shown) and in response is configured to send switching signals to the normally-on transistor 28₁ and the normally-off transistor 32₁. The switching signals indicate when to increase current in the winding and when to deliver the current via the AUX node 36₁ to the auxiliary power supply 16. It is appreciated that diodes 30₁ and 34₁ could be inherent to the internal structures of either or both switches 28₁ and 32₁ respectively rather than being discrete diodes.

FIG. 10 is a circuit schematic of an embodiment for the half-bridge motor driver 12₁ shown in FIG. 1. The ULS switch is a normally-on transistor such as a gallium nitride (GaN) transistor or silicon JFET 40₁ that has a drain configured to receive current I_{W} from the second end 14_{AUX} of the motor winding and a source coupled to the AUX node 36₁. The LLS switch is a normally-off metal oxide semiconductor field effect transistor (MOSFET) 42₁ that has a drain coupled to the AUX node 36₁ and a source coupled to reference ground. The LS Drive Circuits 22₁ receive a signal from the system MCU 18 (not shown) and in response are configured to send a switching signal to the gate of the MOSFET 42₁. A resistor 461 couples from ground to the gate of GaN transistor 40₁. In one embodiment a Zener diode 441 is coupled in parallel to MOSFET 42₁ to provide a clamp to limit the maximum voltage at node 36₁ relative to reference ground. The switching signal indicates when to increase current in the winding and when to deliver current via the AUX node 36₁ to the auxiliary power supply 16.

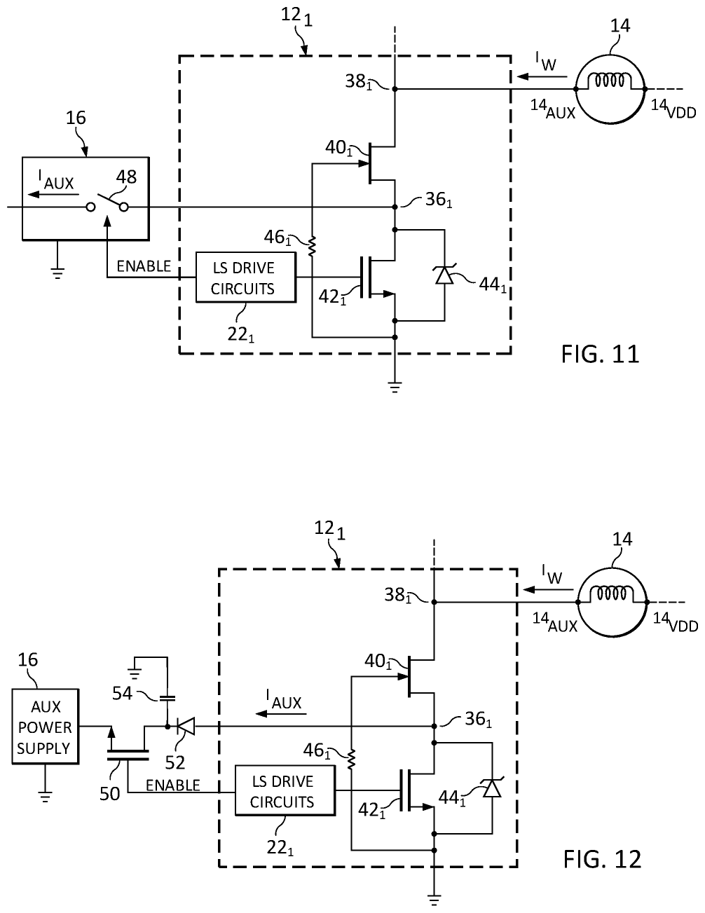

FIG. 11 illustrates another embodiment of how a winding of motor 14 may be configured to provide current to the auxiliary power supply 16. In one embodiment, the ULS switch is a normally-on gallium nitride (GaN) transistor 40₁ that has a drain configured to receive current I_{W} from the second end 14_{AUX} of the motor winding and a source coupled to the AUX node 36₁. The LLS switch is a normally-off MOSFET 42₁ that has drain coupled to the AUX node 36₁ and a source coupled to ground. The LS Drive Circuits 22₁ receive a signal from the system MCU 18 (not shown) and are configured to send a switching signal to the gate of the MOSFET 42₁. A resistor 461 couples from ground to the gate of transistor. The switching signal indicates when to increase current in the winding and when to deliver current via the auxiliary node to the auxiliary power supply 16.

An auxiliary switch 48 that may be part of the auxiliary power supply 16 is coupled to AUX node 36. The auxiliary switch 48 may be a GaN transistor. The LS Drive Circuits 22₁ may be further configured to send an ENABLE signal to the auxiliary switch indicating when to deliver the stored energy via the AUX node to the auxiliary power supply 16.

FIG. 12 illustrates another embodiment of a winding of motor 14 configured to provide current to the auxiliary power supply 16. In one embodiment, the ULS switch is a normally-on GaN transistor 40₁ that has a drain configured to receive current I_{W} from the second end 14_{AUX} of the motor winding and a source coupled to the AUX node 36₁. The LLS switch is a normally-off MOSFET 42₁ that has drain coupled to the AUX node 36₁ and a source coupled to ground. The LS Drive Circuits 22₁ receive a signal from the system MCU 18 (not shown) and in response are configured to send a switching signal to the gate of the MOSFET 42₁. A resistor 461 couples from ground to the gate of GaN transistor 40₁. The switching signal indicates when to establish current in the winding of motor 14 and when to deliver the current via the auxiliary node to the auxiliary power supply 16.

A diode 52 and an external auxiliary switch 50 are coupled between the AUX node 36₁ and the auxiliary power supply 16. A capacitor 54 couples to the cathode of diode 52 and ground. The LS Drive Circuits 22₁ are further configured to send an ENABLE signal to external auxiliary switch 50 indicating when to deliver the stored energy via the AUX node 36₁ to the auxiliary power supply 16.

In this embodiment, the current I_{AUX} may charge a capacitor to a voltage limited by the Zener diode 44 and the transistor 50 may switch current to the auxiliary power supply 16.

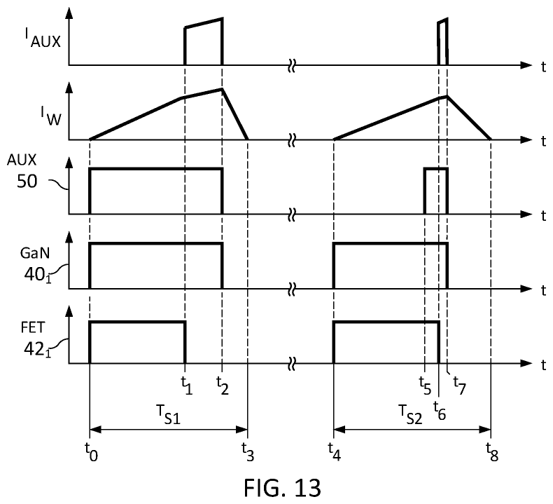

FIG. 13 is a timing diagram illustrating operation of an embodiment for accessing current from the winding shown in FIG. 12. In this embodiment, the auxiliary switch determines when current is delivered to the AUX power supply 16 when the motor is either stationary or in motion during T_{S1} or T_{S2}.

Graph FET shows the state of the FET switch 42₁. Graph GaN shows the state of the GaN switch 40₁. Graph AUX shows the state of the AUX switch 50. A high state indicates that the switch is closed, whereas a low state indicates that the switch is open. Graph I_{W} shows the current in the winding of motor 14. A positive current I_{W} indicates current flowing from the winding of motor 14 to node 38₁ whereas a negative current I_{W} indicates current flowing from node 38₁ to the winding of motor 14. Graph I_{AUX} shows current at the input to the auxiliary power supply 16.

Time duration T_{S1} illustrates when the auxiliary switch 50 and the normally-on GaN transistor 40₁ are controlled synchronously. At t₀, the normally-on GaN transistor 40₁, the normally-off FET 42₁, and the auxiliary switch 50 are closed. Current I_{W} begins to increase. At t₁, when current I_{W} reaches a threshold, the normally-off FET 42₁ is opened. Current is delivered to the auxiliary power supply. At t₂, the normally-on GaN transistor 40₁ and the auxiliary switch 50 are opened. At t₃, there is negligible current in the winding.

Time duration T_{S2} illustrates when the auxiliary switch 50 and the normally-on GaN transistor 40₁ are controlled asynchronously. At ta, the normally-on GaN transistor 40₁ and the normally-off FET 42₁ are closed. Current I_{W} begins to increase. At t₅, the auxiliary switch 50 is closed. At t₆, the normally-off FET 42₁ is opened. Current is delivered to the auxiliary power supply. At t₇, the normally-on GaN transistor 40₁ and the auxiliary switch 50 are opened. At t₅ there is negligible current in the winding.

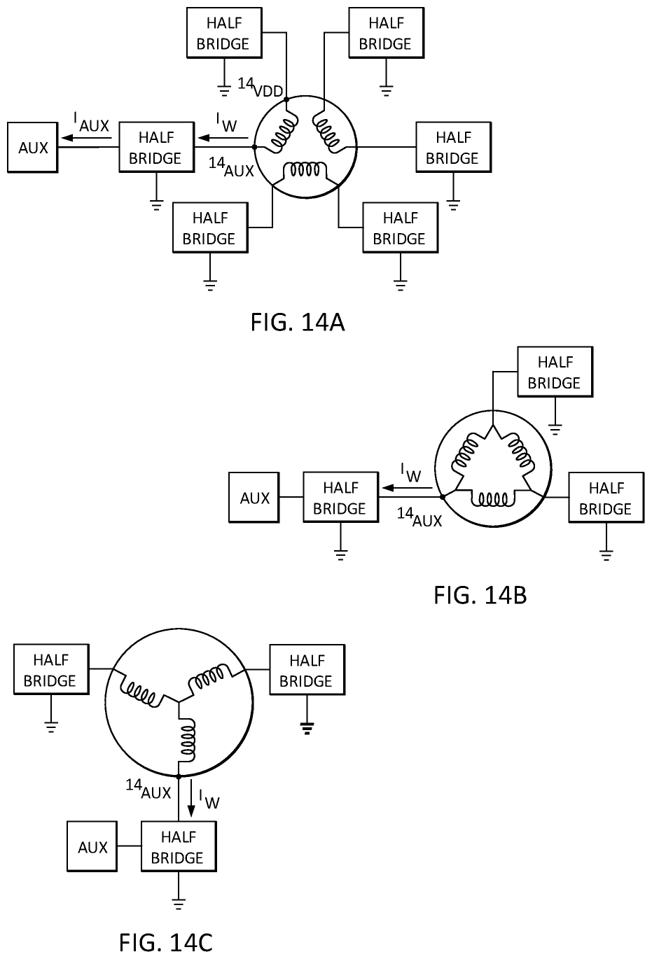

FIGS. 14A, 14B, and 14C illustrate additional embodiments of the system shown in FIG. 1. For each figure, the half-bridge motor driver circuit is coupled between the VDD power supply rail (not shown) and reference ground. In a typical system, a single auxiliary power supply may provide power to all motor driver circuits in the system.

In FIG. 14A, the motor is a three-phase motor having three windings. For each winding, a first half-bridge motor driver circuit is coupled to a first end 14_{VDD} and a second half-bridge motor driver circuit is coupled to a second end 14_{AUX}.

In FIG. 14B, the motor has three windings in the delta configuration. For each pair of windings, a first half-bridge motor driver circuit is coupled to a first end 14_{VDD} of two windings and a second half-bridge motor driver circuit is coupled to a second end 14_{AUX} of two windings.

In FIG. 14C, the motor has three windings in the Y configuration. For each winding, a first half-bridge motor driver circuit is coupled to a first end 14_{VDD} of one winding and second half-bridge motor driver circuit is coupled to a second end 14_{AUX} of a different winding.

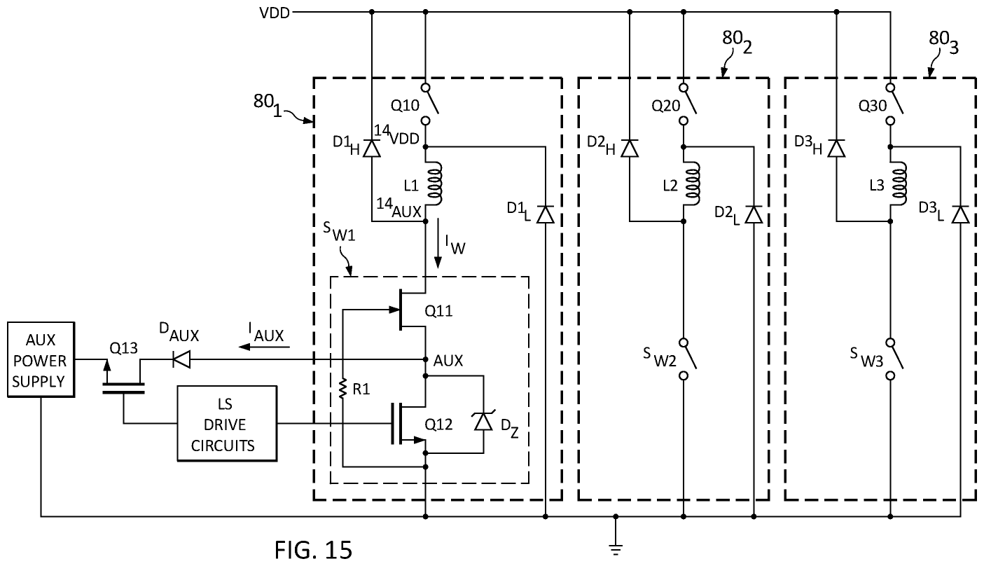

FIG. 15 is a functional block diagram in accordance with another embodiment of the present disclosure. Three circuit blocks 80₁, 80₂, 80₃ are coupled between VDD and reference ground.

As an illustrative example, circuit block 80₁ includes a first switch Q10 having an input terminal coupled to VDD and having an output terminal coupled to the cathode of a diode D1_{L}. The anode of diode D1_{L} is coupled to the reference ground. A motor winding L1 has a first end 14_{VDD} coupling to the output of the first switch Q10 and a second end 14_{AUX} coupling to the input to a composite switch S_{W1}. The output of the composite switch S_{W1} is coupled to reference ground. A diode D1_{H} couples between VDD and the second end 14_{AUX} of the motor winding L1.

The composite switch S_{W1} includes two transistors in a cascode configuration, e.g., of a normally-on transistor Q11 and a normally-off transistor Q12 coupled at the AUX node. The normally-on transistor Q11 may be a GaN transistor whereas the normally-off transistor Q12 may be a MOSFET. A Zener diode D_{Z} is coupled across the normally-off transistor Q12. A resistor R1 couples between the gate of the normally-on transistor Q11 and reference ground.

A diode D_{AUX} couples between the AUX node and the drain of auxiliary switch Q13. The source of auxiliary switch Q13 further couples to the auxiliary power supply. The LS Drive circuits couple to the gate of the normally-off transistor Q12 and to the gate of auxiliary switch Q13.

To increase current in the selected winding, switches Q10, Q11, and Q12 are closed.

To deliver current to the auxiliary power supply, Q12 of the composite switch may be opened to deliver current from the AUX node to the auxiliary switch Q13 until the voltage at the AUX node rises high enough to open switch Q11 of the composite switch. It is appreciated that in another embodiment (not shown) a capacitor could be coupled from the node connecting D_{AUX} and auxiliary switch Q13 to reference ground as shown with capacitor 54 in FIG. 12.

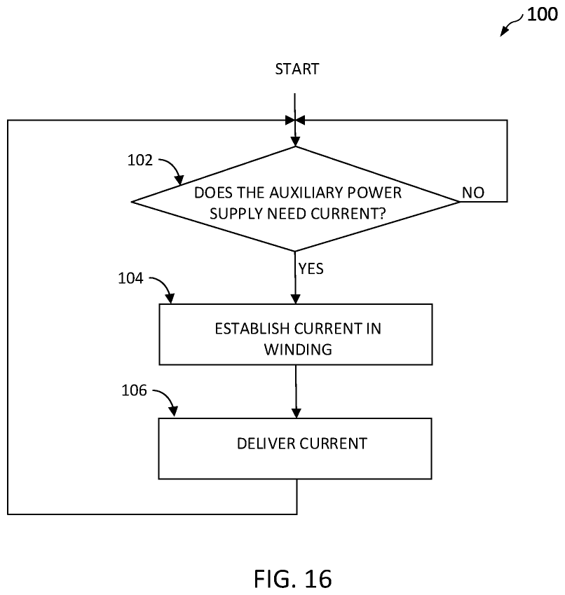

FIG. 16 is a process flowchart 100 according to an embodiment of the present disclosure. In step 102, it is determined whether the auxiliary power supply needs current. If no, step 102 is repeated. If yes, in step 104, current is established in the winding. This may be done by applying one of the example switching diagrams previously disclosed.

In step 106, current from the winding is delivered to the auxiliary power supply.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

By way of illustration, a switched-mode power converter could have an inductive energy storage element that is a winding of a motor. As described earlier, in a first state, energy could be stored as current in the winding of the motor and in a second state, a portion of the current in the winding may be delivered to an auxiliary node. DC to dc converters could be modified accordingly. Suitable dc to dc converters may include variations of members of the families of flyback converters, buck converters, and boost converters. The first and second states would be based on the operating parameters of the load, of duty cycle, time, current in the winding, and power needs of the auxiliary power supply. To illustrate, the power need may be a comparison of the desired output quantity, e.g. voltage, to a reference voltage.

We claim:

1. A motor driver for coupling to an auxiliary power supply and to a winding of a motor, the motor driver comprising:
a switching circuit having an auxiliary node coupled to the auxiliary power supply and a winding node coupled to the winding, the switching circuit coupled to receive current and to deliver current; and
control circuitry coupled to the switching circuit to switch the switching circuit to receive current and to switch the switching circuit to deliver current,
wherein the switching circuit and the winding establish a current in the winding when the switching circuit is switched to store energy in an inductance of the winding and to deliver current to the auxiliary node when the switching circuit is switched to deliver current.

2. The motor driver of claim 1, the switching circuit comprising:
an upper switch coupled to the winding node and to the auxiliary node, and
a lower switch coupled to the auxiliary node and to a reference ground, wherein the control circuitry is coupled to send a control signal to the switching circuit, wherein the control signal indicates when to store energy as current and when to deliver current.

3. The motor driver of claim 2, the upper switch and the lower switch comprising a cascode configuration of a normally-on transistor and a normally-off transistor.

4. The motor driver of claim 3, wherein the normally-on transistor is selected from a group consisting of GaN transistors and SiC transistors.

5. The motor driver of claim 3, wherein the normally-off transistor is a MOSFET.

6. The motor driver of claim 3, wherein the switching circuit is an integrated circuit.

7. The motor driver of claim 2, wherein the switching circuit is coupled to increase current in the winding when the motor is stationary and the switching circuit is coupled to deliver current to the auxiliary power supply.

8. The motor driver of claim 2, wherein the switching circuit is coupled to increase current in the winding when the motor is in motion and the switching circuit is coupled to deliver current to the auxiliary power supply.

9. A system comprising:
a switch of a first motor driver coupled to a supply rail;
a motor having a winding coupled to the switch;
a second motor driver having a winding node coupled to the winding to receive current and to deliver current; and
an auxiliary power supply coupled to the second motor driver,
wherein the switch of the first motor driver and the second motor driver are coupled to establish a current in the winding when the second motor driver is coupled to receive current and to deliver current to the auxiliary power supply when the second motor driver is coupled to deliver current.

10. The system as in claim 9, the motor driver comprising:
control circuitry coupled to send a control signal indicating when to deliver current; and
a switching circuit coupled to the winding node, the switching circuit having an auxiliary node coupled to the auxiliary power supply, the switching circuit further coupled to receive the control signal, the switching circuit comprising,
an upper switch coupled to the winding node and to the auxiliary node, and
a lower switch coupled to the auxiliary node and to a reference ground,
wherein the switching circuit increases current in the winding in response to the control signal, and
wherein the switching circuit sends an enable signal indicating when the current is to be delivered to the auxiliary power supply.

11. The system of claim 10, wherein:
the current is increased in the winding above a threshold that generates motor motion when the motor is in motion and the switching circuit is coupled to deliver current; and
the current is increased in the winding without generating continuous motor motion when the motor is stationary and the switching circuit is coupled to deliver current.

12. The system of claim 11, further comprising an auxiliary switch coupled to the auxiliary node and to the auxiliary power supply, wherein the auxiliary switch is coupled to receive the enable signal from the switch circuitry.

13. The system of claim 10, wherein the switching circuit is coupled to deliver current based on operating parameters of the auxiliary power supply, wherein the operating parameters are selected from a group consisting of duty cycle, time, current in the winding, and power needs of the auxiliary power supply.

14. A method for coupling a winding of a motor to an auxiliary power supply comprising:
storing energy in the winding inductance; and
delivering a portion of the energy from the winding inductance to the auxiliary power supply.

15. The method of claim 14, storing energy comprising increasing a current in the winding above a current that generates motor motion when the motor is in motion.

16. The method of claim 14, storing energy comprising increasing a current in the winding when the motor is stationary.

17. The method as in claim 16, wherein increasing a current and delivering a portion of the energy are based on operating parameters of the auxiliary power supply, wherein the operating parameters are selected from a group consisting of duty cycle, time, current in the winding, and power needs of the auxiliary power supply.

18. A switched-mode power converter comprising,
an inductive energy transfer element having a first end and a second end, wherein the inductive energy transfer element comprises a winding of a motor;
a switching circuit having an auxiliary node, the switching circuit coupled to the first end of the winding and to reference ground; and
a drive circuit compromising the switching circuit, the drive circuit receiving a control signal that indicates when to store energy in the winding inductance and when to deliver energy to the auxiliary node,
wherein the switching circuit establishes a current in the winding when the control signal indicates a need to store energy, and
wherein the switching circuit delivers the energy in the winding inductance to the auxiliary node when the control signal indicates a need to deliver energy to the auxiliary node.

19. The switched-mode power converter of claim 18, wherein the switched-mode power converter is a dc-to-dc converter.

20. The switched-mode power converter of claim 19, wherein:
the switched-mode power converter is coupled to receive current and to deliver current based on operating parameters of an auxiliary power supply coupled to the auxiliary node, and
the operating parameters are selected from a group consisting of duty cycle, time, current in the winding, and power needs of the auxiliary power supply.
